(19) United States
(12) Patent Application Publication
(10) Pub. No.: US 2017/0037274 A1
(43) Pub. Date: Feb. 9, 2017

(54) COATING COMPOSITIONS CONTAINING N-ALKOXYMETHYL(METH)ACRYLAMIDE POLYMER CURING AGENTS SUITABLE FOR COATING CONTAINERS

(71) Applicant: PPG Industries Ohio, Inc., Cleveland, OH (US)

(72) Inventors: Sarah Cunningham, Amelia, OH (US); Youssef Moussa, Loveland, OH (US)

(73) Assignee: PPG Industries Ohio, Inc., Cleveland, OH (US)

(21) Appl. No.: 14/817,249

(22) Filed: Aug. 4, 2015

(51) Int. Cl. C09D 133/26; B05D 1/02

(52) U.S. Cl. CPC C09D 133/26; B05D 1/02

(57) ABSTRACT

A coating composition comprising:
(a) a polymer containing reactive groups selected from N-alkoxymethylamide groups and hydroxyl groups in which the reactive group equivalent weight of the polymer is from 500 to 50,000,
(b) a polymer prepared by the polymerization of ethylenically unsaturated monomers including an N-alkoxymethyl(meth)acrylamide monomer;
the polymer (b) having an N-alkoxymethylamide equivalent weight of 200 to 600;
the equivalent weight of (a) being at least 20 percent greater than (b) and the coating composition being substantially free of bisphenol A and derivatives thereof
   is disclosed.

### FIELD OF THE INVENTION

The present invention relates to coating compositions suitable for coating food and beverage containers. More particularly, the invention relates to coating compositions containing novel curing agents based on N-alkoxymethyl(meth)acrylamide containing polymers.

### BACKGROUND OF THE INVENTION

Coatings compositions for coating food and beverage containers are typically thermosetting compositions containing active hydrogen containing polymers such as (meth)acrylic polyols or polyester polyols and triazine-based curing agents, typically curing agents based on melamine or benzoguanamine condensates with formaldehyde or condensates of formaldehyde with phenol or substituted phenol such as cresol. Many of these curing agents have numerous disadvantages such as high cost, slow reaction time, limited reactivity and yellowing of the resultant cured coating. It would be desirable to formulate container coating compositions with an alternate curing agent that avoids or minimizes the numerous disadvantages associated with the conventional curing agents.

### SUMMARY OF THE INVENTION

The present invention provides a coating composition comprising:
(a) a polymer containing reactive groups selected from N-alkoxymethylamide groups and hydroxyl groups in which the reactive group equivalent weight of the polymer is from 580 to 50,000,
(b) a polymer prepared by the polymerization of ethylenically unsaturated monomers including an N-alkoxymethyl(meth)acrylamide monomer;

the polymer (b) having an N-alkoxymethylamide equivalent weight of 200 to 600

the equivalent weight of (a) being at least 20 percent greater than (b) and the coating composition being substantially free of bisphenol A and derivatives thereof.

The present invention also provides an article comprising a body portion or an end portion of a food or beverage can and the coating composition as described above disposed thereon.

The present invention also provides a method comprising:
(a) providing the coating composition as described above and
(b) applying the coating composition to a metal substrate prior to or after forming the metal substrate into a food or beverage can or portion thereof.

### DETAILED DESCRIPTION

As used herein, unless otherwise expressly specified, all numbers such as those expressing values, ranges, amounts or percentages may be read as if prefaced by the word “about”, even if the term does not expressly appear. Moreover, it should be noted that plural terms and/or phrases encompass their singular equivalents and vice versa. For example, “a” polymer, “a” crosslinker, and any other component refers to one or more of these components.

When referring to any numerical range of values, such ranges are understood to include each and every number and/or fraction between the stated range minimum and maximum.

As employed herein, the term “polyol” or variations thereof refers broadly to a material having an average of two or more hydroxyl groups per molecule. The term “polycarboxylic acid” refers to the acids and functional derivatives thereof, including anhydride derivatives where they exist, and lower alkyl esters having 1-4 carbon atoms.

As used herein, the term “polymer” refers broadly to prepolymers, oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, ethacrylic acid, etc., and their C₁-C₅ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The terms “acrylic polymer” and “(meth)acrylic polymer” refer to polymers prepared from one or more (meth)acrylic monomers.

As used herein, “a” and “the at least one” and “one or more” are used interchangeably. Thus, for example, a coating composition that comprises “a” polymer can be interpreted to mean the coating composition includes “one or more” polymers.

As used herein, the molecular weights are determined by gel permeation chromatography using a polystyrene standard. Unless otherwise indicated, molecular weights are on a number average basis (Mₙ).

The polymer (a) may be a (meth)acrylic polymer and/or a polyester polymer. The (meth)acrylic polymer is preferably a polymer derived from one or more (meth)acrylic monomers. Furthermore, blends of (meth)acrylic monomers and vinyl aromatic monomers can be used. Useful monomers are (meth)acrylic acid, methyl (meth)acrylate, ethyl (meth)acrylate, butyl (meth)acrylate, styrene and vinyl toluene. The polymer (a) also contains reactive groups selected from hydroxyl groups and N-alkoxymethylamide groups. The hydroxyl groups are derived from hydroxy-substituted (meth)acrylic acid esters such as hydroxyethyl (meth)acrylate and hydroxypropyl (meth)acrylate. The N-alkoxymethylamide groups are derived from N-alkoxymethyl(meth)acrylamide monomers having 1 to 8, such as 1 to 4 carbon atoms in the N-alkoxy group. Examples of suitable monomers include N-ethoxymethyl(meth)acrylamide and N-butoxymethyl(meth)acrylamide. The number average molecular weight (Mₙ) of the acrylic polymer component is at least 1,000, such as from 15,000 to 100,000, and a reactive group equivalent weight of 580 to 50,000, such as 1000 to 45,000 and 2000 to 35,000.

The (meth)acrylic polymer is prepared using known free radical polymerization methods carried out in organic solvent. Examples of suitable solvents are n-butanol and 2-butoxyethanol including mixtures thereof. Examples of free radical initiators include peroxides and azobiscarbonitriles. The (meth)acrylic polymer (a) can also contain carboxylic acid groups that can be at least partially neutralized with a base enabling (a) and (b) of the coating composition to be dispersed in an aqueous diluent. Typically, a monomer mixture and initiator are added to the reaction vessel over a period of one to four hours with a polymerization temperature of 60 to 165° C.

Besides (meth)acrylic polymers, polyester polymers can comprise polymer (a). The polyester polymers contain hydroxyl groups and are prepared by processes well known in the art comprising the condensation polymerization reaction of one or more polycarboxylic acids with one or more polyols. Examples of suitable polycarboxylic acids are phthalic acid, isophthalic acid, terephthalic acid, 1,4-cyclohexane dicarboxylic acid, succinic acid, sebacic acid, methyltetrahydrophthalic acid, methylhexahydrophthalic acid, tetrahydrophthalic acid, dodecane dioic acid, adipic acid, azelaic acid, naphthylene dicarboxylic acid, pyromellitic acid, dimer fatty acids and maleic acid.

The polyol component is, for example, selected from diols or triols and preferably from mixtures thereof. Examples of suitable polyols include ethylene glycol, 1,3-propanediol, diethylene glycol, dipropylene glycol, triethylene glycol, 1,4-butanediol, 2-methyl-1,3-propanediol, 1,4-cyclohexane dimethanol, 1,6-hexanediol, neopentyl glycol, trimethylolpropane, glycerol and dimethyl propionic acid. The polyester polymer preferably has a number average molecular weight between 1000 and 20,000.

The polyester polymers typically have a hydroxyl equivalent weight of 300 to 10,000, such as 500 to 8000, and 500 to 2000.

Polymer (a) is typically present in the coating compositions in amounts of 70 to 95, such as 75 to 90 percent by weight based on total resin solids weight of (a) and (b).

The curing or crosslinking agent (b) for polymer (a) is a polymer prepared by the polymerization of ethylenically unsaturated monomers including N-alkoxymethyl(meth)acrylamide having from 1 to 8, such as 1 to 4 carbon atoms in the N-alkoxy group. Examples of suitable monomers are N-butoxymethyl(meth)acrylamide, N-ethoxymethyl(meth)acrylamide and N-isobutoxymethyl(meth)acrylamide. The N-alkoxymethyl(meth)acrylamide is typically used in amounts of 20 to 60, such as 20 to 40 percent by weight based on total weight of the ethylenically unsaturated monomers used in preparing the copolymer.

The other ethylenically unsaturated monomers in (b) can be vinyl aromatic monomers such as styrene and vinyl toluene and alkyl esters of (meth)acrylic acid containing from 1 to 12 carbon atoms in the alkyl group. Specific examples include methyl (meth)acrylate, ethyl (meth)acrylate, butyl (meth)acrylate and lauryl (meth)acrylate.

The curing agent typically has a number average molecular weight of 1,000 to 25,000, such as 10,000 to 15,000, and an N-alkoxymethylamide equivalent weight of 200 to 600, such as 200 to 500.

The curing agent is present in the composition in amounts of 5 to 30, such as 10 to 25 percent by weight based on total resin solids weight of (a) and (b).

Typically, the equivalent weight of (a) is at least 20 such as at least 30 percent greater than (b).

The curing agent (b) is prepared using known free radical polymerization methods carried out in organic solvent. Examples of suitable solvents are n-butanol and 2-butoxyethanol including mixtures thereof. Examples of free radical initiators include peroxides and azobiscarbonitriles. Typically a monomer mixture and initiator are added to the reaction vessel over a period of one to four hours with a polymerization temperature of 60 to 150° C.

The coating composition typically contains a diluent, such as water, or an organic solvent or a mixture of water and organic solvent to dissolve or disperse the ingredients of the composition. The organic solvent is selected to have sufficient volatility to evaporate essentially entirely from the coating composition during the curing process such as during heating from 175-205° C. for about 5 to 15 minutes. Examples of suitable organic solvents are aliphatic hydrocarbons such as mineral spirits and high flash point VM&P naphtha; aromatic hydrocarbons such as benzene, toluene, xylene and solvent naphtha 100, 150, 200 and the like; alcohols, for example, ethanol, n-propanol, isopropanol, n-butanol and the like; ketones such as acetone, cyclohexanone, methylisobutyl ketone and the like; esters such as ethyl acetate, butyl acetate, and the like; glycols such as butyl glycol, glycol ethers such as methoxypropanol and ethylene glycol monomethyl ether and ethylene glycol monobutyl ether and the like. Mixtures of various organic solvents can also be used. For aqueous compositions, the active hydrogen-containing polymer typically has carboxylic acid groups that are at least partially neutralized with a base such as sodium hydroxide or an amine such as dimethylethanolamine to assist in the dispersion or dissolution of the resinous ingredients in the coating composition. The diluent is typically present in the coating compositions in amounts of about 20 to 80, such as 30 to 70 percent by weight based on total weight of the coating composition.

Adjuvant curing agents such as phenolplasts or phenol-formaldehyde resins and aminoplast or triazine-formaldehyde resins can optionally be included in the coating composition. The phenol-formaldehyde resins are typically of the resol type. Examples of suitable phenols are phenol itself, butyl phenol, xylenol and cresol. Cresol-formaldehyde resins, the types typically etherified with butanol, are often used. For the chemistry in preparation of phenolic resins, reference is made to “The Chemistry and Application of Phenolic Resins or Phenolplasts”, Vol. V, Part I, edited by Dr. Oldring; John Wiley & Sons/Cita Technology Limited, London, 1997. Examples of commercially available phenolic resins are PHENODUR® PR285 and BR612 and those resins sold under the trademark BAKELITE®, typically BAKELITE 6581LB.

Examples of aminoplast resins are those which are formed by reacting a triazine such as melamine or benzoguanamine with formaldehyde. Typically, these condensates are etherified typically with methanol, ethanol, butanol including mixtures thereof. For the chemistry preparation and use of aminoplast resins, see “The Chemistry and Applications of Amino Crosslinking Agents or Aminoplast”, Vol. V, Part II, page 21 ff., edited by Dr. Oldring; John Wiley & Sons/Cita Technology Limited, London, 1998. These resins are commercially available under the trademark MAPRENAL® such as MAPRENAL MF980 and under the trademark CYMEL® such as CYMEL 303 and CYMEL 1128, available from Cytec Industries. When present the adjuvant curing agent is present in amount of up to 30, such as 2 to 30 percent by weight based on weight of resin solids of the coating composition.

Adjuvant resins such as polyether polyols, polyurethane polyols and hydroxyl-containing polybutadiene optionally may also be included in the coating compositions to maximize certain properties of the resultant coating. When present, the adjuvant resin is used in amounts of up to 50, typically 2-50 percent by weight based on weight of resin solids of the coating composition.

Another optional ingredient that is typically present in the coating composition is a catalyst to increase the rate of cure or crosslinking of the coating compositions. Generally acid catalyst may be used and is typically present in amounts of about 0.05 to 5 percent by weight. Examples of suitable catalysts are dodecyl benzene sulfonic acid, methane sulfonic acid, paratoluene sulfonic acid, dinonyl naphthalene disulfonic acid and phenyl phosphonic acid.

Another useful optional ingredient is a lubricant, for example, a wax which facilitates manufacture of metal closures by imparting lubricity to the sheets of the coated metal substrate. Preferred lubricants include, for example, carnauba wax and polyethylene-type lubricants. If used, the lubricant is preferably present in the coating compositions of at least 0.1 percent by weight based on weight of resin solids in the coating composition.

Another useful optional ingredient is a pigment such as titanium dioxide. If used, the pigment is present in the coating compositions in amounts no greater than 70 percent by weight, preferably no greater than 40 percent by weight based on total weight of solids in the coating composition.

Surfactants can optionally be added to the coating composition to aid in flow and wetting of the substrate. Examples of suitable surfactants include, but are not limited to, nonyl phenol polyether and salts. If used, the surfactant is present in amounts of at least 0.01 percent and no greater than 10 percent based on weight of resin solids in the coating composition.

In certain embodiments, the compositions used in the practice of the invention are substantially free, may be essentially free and may be completely free of bisphenol A and derivatives or residues thereof, including bisphenol A (“BPA”) and bisphenol A diglycidyl ether (“BADGE”). Such compositions are sometimes referred to as “BPA non intent” because BPA, including derivatives or residues thereof, are not intentionally added but may be present in trace amounts because of unavoidable contamination from the environment. The compositions can also be substantially free and may be essentially free and may be completely free of bisphenol F and derivatives or residues thereof, including bisphenol F and bisphenol F diglycidyl ether (“BPFG”). The term “substantially free” as used in this context means the compositions contain less than 1000 parts per million (ppm), “essentially free” means less than 100 ppm and “completely free” means less than 20 parts per billion (ppb) of any of the above-mentioned compounds, derivatives or residues thereof.

The compositions of the present invention can be prepared according to methods well known in the art. For example, using an acid functional (meth)acrylic polymer as polymer (a), the polymer is neutralized with an amine to between 20-80 percent of the total theoretical neutralization. The neutralized acrylic polymer is then dispersed in water followed by the curing agent (b). The mixture is then thinned with more water to achieve a manageable viscosity. Additives are then added followed by thinning with additional water to achieve the desired solids and viscosity.

As mentioned above, the coating compositions of the present invention can be applied to containers of all sorts and are particularly well adapted for use on food and beverage cans (e.g., two-piece cans, three-piece cans, etc.).

The compositions can be applied to the food or beverage container by any means known in the art such as roll coating, spraying and electrocoating. It will be appreciated that for two-piece food cans, the coating will typically be sprayed after the can is made. For three-piece food cans, a flat sheet will typically be roll coated with one or more of the present compositions first and then the can will be formed. As noted above, the percent solids of the composition can be adjusted based upon the means of application. The coating can be applied to a dry film weight of 24 mgs/4 in² to 12 mgs/4 in², such as 20 mgs/4 in² to 14 mgs/4 in².

After application, the coating is then cured. Cure is effected by methods standard in the art. For coil coating, this is typically a short dwell time (i.e., 9 seconds to 2 minutes) at high heat (i.e., 485° F. (252° C.) peak metal temperature); coated metal sheets typically cure longer (i.e., 10 minutes) but at lower temperatures (i.e., 400° F. (204° C.) peak metal temperature). For spray applied coatings on two-piece cans, the cure can be from 5 to 8 minutes, with a 90-second bake at a peak metal temperature of 415° F. (213° C.) to 425° F. (218° C.).

Any material used for the formation of food cans can be treated according to the present methods. Particularly suitable substrates include aluminum, tin-plated steel, tin-free steel and black-plated steel.

The coatings of the present invention can be applied directly to the steel, without any pretreatment or adhesive aid being added to the metal first. In addition, no coatings need to be applied over top of the coatings used in the present methods.

The compositions of the present invention perform as desired both in the areas of flexibility and corrosion/acid resistance.

### EXAMPLES

The following examples are offered to aid in understanding of the present invention and are not to be construed as limiting the scope thereof. Unless otherwise indicated, all parts and percentages are by weight.

The Examples show the following:

Example A shows the preparation of an N-butoxymethylacrylamide-containing (meth)acrylic polymer curing agent (N-butoxymethylamide functional equivalent weight of 565). Example B is of a carboxylic acid functional (meth)acrylic polymer containing N-butoxymethylacrylamide moieties (N-butoxymethylamide functional equivalent weight of 33,520). Examples A and B were combined to form a coating composition of Example 1. Example C shows the preparation of a carboxylic acid (meth)acrylic polymer that also contains N-butoxymethylacrylamide moieties. Example C was used to form a coating composition as set forth in Example 2. The N-butoxymethylacrylamide content in Example A+B and in Example C was approximately 6 percent by weight based on total weight of polymerizable monomers used in preparing the (meth)acrylic polymers of Examples A+B and C.

The coating compositions of Examples 1 and 2 were spray applied to the interior surface of food cans. The coatings were cured and the cans were filled with chicken noodle soup, sealed and stored for 1 and 3 weeks at 120° F. (49° C.). After storage, the cans were opened and the coating evaluated for staining, coating integrity and corrosion resistance. The results are reported in Table III.

### Example A

### Preparation of N-Butoxymethylacrylamide (NBMA) (Meth)Acrylic Polymer Curing Agent

The following solvents were added to a 5-liter glass flask: 460.54 g of 2-butoxyethanol and 72.55 g of deionized water. Under agitation and a nitrogen blanket, the flask contents were heated to reflux (215° F. [102° C.]). Once refluxing, the monomer/initiator mixture (see Table I below) was added to the flask over 90 minutes. When the monomer/initiator addition was complete, 17.57 g of 2-butoxyethanol was added to the flask as a rinse and the mixture was held at reflux for 15 minutes. Following the hold, 17.92 g of T-butyl peroctoate initiator was added to the flask as chaser #1 and the mixture was held at reflux for 60 minutes. Then, a second addition of 17.92 g of T-butyl peroctoate was added as chaser #2, along with a 17.57 g 2-butoxyethanol rinse, and the mixture was held at reflux for 60 minutes. After the second chaser hold, the heat was turned off and 722.05 g of 2-butoxyethanol was added as the resin cooled to room temperature. The curing agent had a molecular weight of 14,000, an NBMA equivalent weight of 565 and a resin solids content of 50 percent by weight.

TABLE I

| | | | Percent by |
|---|---|---|---|
| | Components | Amount (g) | Weight |
| Monomers | N-butoxymethylacrylamide | 537.63 | 31.2 |
| | Styrene | 686.93 | 37.7 |
| | Ethyl Acrylate | 567.55 | 31.1 |
| Initiator | T-butyl Peroctoate | 107.53 | |

### Example B

A carboxylic acid functional (meth)acrylic polymer containing 0.5 percent NBMA moieties was prepared by free radical polymerization in n-butanol. The resulting polymer had an Mₙ of 20,000, an NBMA equivalent weight of 33,520 and a theoretical solids content of 50 percent by weight in n-butanol. The polymer was partially neutralized (40 percent of total theoretical neutralization with dimethylethanolamine) and dispersed in water at a theoretical solids content of 35 percent by weight.

### Example C

### Preparation of NBMA/Acid-Functional (Meth)Acrylic Polymer

The following solvents were added to a 3-liter glass flask: 261.26 g of 2-butoxyethanol and 41.16 g of deionized water. Under agitation and a nitrogen blanket, the flask contents were heated to reflux (215° F. [102° C.]). Once refluxing, the monomer/initiator mixture (see Table II below) was added to the flask over 90 minutes. When the monomer/initiator addition was complete, 9.97 g of 2-butoxyethanol was added to the flask as a rinse and the mixture was held at reflux for 15 minutes. Following the hold, 10.17 g of T-butyl peroctoate initiator was added to the flask as chaser #1 and the mixture was held at reflux for 60 minutes. Then, a second addition of 10.17 g of T-butyl peroctoate was added as chaser #2, along with a 9.97 g 2-butoxyethanol rinse, and the mixture was held at reflux for 60 minutes. After the second chaser hold, the temperature set point was decreased to 180° F. (82° C.). Once the temperature reached 200° F. (93° C.), 110.15 g of dimethylethanolamine was added to the resin, followed by a 30-minute addition of 1299.01 g deionized water. Following the water addition, the resin was cooled to room temperature while agitating.

TABLE II

| | | | Percent by |
|---|---|---|---|
| | Components | Amount (g) | Weight |
| Monomers | Methacrylic Acid | 266.11 | 26.2 |
| | N-butoxymethylacrylamide | 64.90 | 6.4 |
| | Styrene | 282.40 | 27.8 |
| | Ethyl Acrylate | 403.22 | 39.6 |
| Initiator | T-butyl Peroctoate | 61.00 | |

### Example 1

An aqueous coating composition was obtained by mixing with a Cowles disperser 127.64 grams of the (meth)acrylic polymer of Example A and 700.51 grams of the (meth)acrylic polymer of Example B, along with other formulation components including phenolic resins, hydroxyl functional polybutadiene, alkylated benzoguanamine-formaldehyde, and butanol, deionized water, and other additives.

### Example 2

### Comparative

An aqueous coating composition was obtained by mixing with a Cowles disperser 700.51 grams of the (meth)acrylic polymer of Example C with other formulation components including phenolic resins, hydroxyl functional polybutadiene, alkylated benzoguanamine-formaldehyde, butanol, deionized water, and other additives in the same ratios as Example 1.

The coating compositions of Examples 1-2 were spray applied to the interior surface of 211×400 electro tin plated steel 2-piece D&I cans at a film weight of 220 mg±10 mg and the can ends at a coating weight of 16-18 mg/4 in². The coatings were cured by heating the can in a 4-zone IBO oven to achieve 400° F. (204° C.) on the dome (bottom of the can) for 90 seconds for 5 minutes total bake. The can ends were seamed onto the can body containing chicken noodle soup filled to ½ inch (1.27 cm) head space. The can was steam processed for 60 minutes at 121° C. and stored at 120° F. (49° C.) for three weeks. The cans were removed from storage after one and three weeks, cooled and cut open with four vertical cuts from top to bottom and flattened to resemble a cross and the interior coated surfaces of the can evaluated for coating integrity and corrosion. The can ends were evaluated for coating integrity.

Coating integrity was determined by the WACO Enamel Rater Test. This test determines the integrity of a fabricated can end by quantifying metal exposure. The end is secured by vacuum to the electrolyte-filled and electrode-containing end fixture. Fixture and specimen are inverted so that electrode and the product side of the end come into contact with the electrolyte solution and the edge of the sample contacts a metal chisel, completing the circuit. The instrument then applies a constant voltage (normally 6.3 VDC) across the coated surface and measures the resulting current at the industry standard of 4 seconds duration. The magnitude of the reading in milliamps (mA) is directly proportional to the amount of exposed metal in the test sample. A low reading is desirable since that indicates there is very little exposed metal on the end. The ends produced for the experiments in this patent were B-64 type ends made on a Minster Press (Minster Machine Company of Minster, Ohio) and B-64 tooling designed by DRT Mfg. Co. of Dayton, Ohio.

For staining, a “0” indicates severe discoloration. A “10” indicates no evidence of staining.

For corrosion protection, a “0” indicates the coating is completely corroded, observed by bubbling or blistering of the film in all areas. A “10” indicates no evidence of corrosion.

The results of the testing on three cans for each example are reported in Table III below.

TABLE III

| | Metal Exposure | Corrosion | | | | | |
|---|---|---|---|---|---|---|---|
| Staining | (mA) | H | A | B | C | D | E |

Example 1:

| | | | | | | | | |
|---|---|---|---|---|---|---|---|---|
| 1 Week: | | | | | | | | |
| 1 | 10 | 9.1 | 5 | 8 | 10 | 10 | 10 | 10 |
| 2 | 10 | 14.6 | 5 | 8 | 10 | 10 | 9 | 8 |
| 3 | 10 | 34.3 | 4 | 8 | 10 | 10 | 9 | 9 |
| 3 Weeks: | | | | | | | | |
| 1 | 5 | 10.7 | 2 | 7 | 10 | 10 | 9 | 5 |
| 2 | 5 | 3.6 | 2 | 6 | 10 | 10 | 9 | 7 |
| 3 | 8 | 3.5 | 3 | 7 | 10 | 10 | 9 | 6 |

Example 2:

| | | | | | | | | |
|---|---|---|---|---|---|---|---|---|
| 1 Week: | | | | | | | | |
| 1 | 5 | 25 | 1 | 7 | 10 | 10 | 8 | 6 |
| 2 | 8 | 22.1 | 1 | 6 | 10 | 10 | 7 | 7 |
| 3 | 5 | 15.1 | 0 | 6 | 10 | 10 | 9 | 7 |
| 3 Weeks: | | | | | | | | |
| 1 | 3 | 3.7 | 0 | 5 | 10 | 10 | 9 | 7 |
| 2 | 3 | 4.9 | 0 | 6 | 10 | 10 | 8 | 7 |
| 3 | 3 | 2.1 | 1 | 5 | 10 | 10 | 8 | 8 |

Key:
H = Extreme upper headspace (pressure ridge).
A = Upper side wall.
B = Side wall beads.
C = Lower side wall.
D = Dome of can.
E = Moat and lower roll bead.

Whereas particular embodiments of this invention have been described above for purposes of illustration, it will be evident to those skilled in the art that numerous variations of the details of the present invention may be made without departing from the invention as defined in the appended claims.

Although various embodiments of the invention have been described in terms of “comprising”, embodiments consisting essentially of or consisting of are also within the scope of the present invention.

1. A coating composition suitable for coating food and beverage containers comprising:
(a) a polymer containing reactive groups selected from N-alkoxymethylamide groups and hydroxyl groups in which the reactive group equivalent weight of the polymer is from 580 to 50,000,
(b) a polymer prepared by the polymerization of ethylenically unsaturated monomers including an N-alkoxymethyl(meth)acrylamide monomer;
the polymer (b) having an N-alkoxymethylamide equivalent weight of 200 to 600;
the equivalent weight of (a) being at least 20 percent greater than (b) and the coating composition being substantially free of bisphenol A and derivatives thereof.

2. The coating composition of claim 1 in which the polymer (a) is selected from the class consisting of (meth)acrylic polymers and polyesters.

3. The coating composition of claim 1 in which the polymer (a) contains carboxylic acid groups.

4. The coating composition of claim 1 in which the reactive groups of polymer (a) are N-alkoxymethylamide groups.

5. The coating composition of claim 1 in which the N-alkoxy groups of the N-alkoxymethyl(meth)acrylamide monomer contain from 1 to 8 carbon atoms.

6. The coating composition of claim 1 in which the ethylenically unsaturated monomers are selected from vinyl aromatic monomers and (meth)acrylic monomers.

7. The coating composition of claim 6 in which the (meth)acrylic monomer is an alkyl ester of (meth)acrylic acid containing from 1 to 12 carbon atoms in the alkyl group.

8. The coating composition of claim 1 in which polymer (a) contains carboxylic acid groups that are at least partially neutralized with a base and (a) and (b) are dispersed in an aqueous diluent.

9. The coating composition of claim 1 in which (a) is present in amounts of 70 to 95 percent by weight and (b) is present in amounts of 5 to 30 percent by weight; the percentage by weight being based on total weight of the resin solids.

10. The coating composition of claim 1 in which (a) is present in amounts of 75 to 90 percent by weight and (b) is present in amounts of 10 to 30 percent by weight; the percentage by weight being based on total weight of the resin solids.

11. An article comprising a body portion or an end portion of a food or beverage can and the coating composition of claim 1 disposed thereon.

12. The article of claim 11 in which the polymer (a) is selected from the class consisting of (meth)acrylic copolymers and polyesters.

13. The article of claim 11 in which the reactive groups of polymer (a) are N-alkoxymethylamide groups.

14. The article of claim 11 in which polymer (a) contains carboxylic acid groups that are at least partially neutralized with a base and (a) and (b) are dispersed in an aqueous diluent.

15. The article of claim 11 in which (a) is present in amounts of 70 to 95 percent by weight and (b) is present in amounts of 5 to 30 percent by weight; the percentage by weight being based on total weight of the resin solids.

16. A method comprising:
(a) providing the coating composition of claim 1 and
(b) applying the coating composition to a metal substrate prior to or after forming the metal substrate into a food or beverage can or portion thereof.

17. The method of claim 16 in which the polymer (a) is selected from the class consisting of (meth)acrylic copolymers and polyesters.

18. The method of claim 16 in which the reactive groups of polymer (a) are N-alkoxymethylamide groups.

19. The method of claim 16 in which polymer (a) contains carboxylic acid groups that are at least partially neutralized with a base and (a) and (b) are dispersed in an aqueous diluent.

20. The method of claim 16 in which (a) is present in amounts of 70 to 95 percent by weight and (b) is present in amounts of 5 to 30 percent by weight; the percentage by weight being based on total weight of the resin solids.
